(19) United States
(12) Patent Application Publication
(10) Pub. No.: US 2003/0004265 A1
(43) Pub. Date: Jan. 2, 2003

(54) Polyurea coating composition

(76) Inventors: Laxmi C. Gupta, Los Alamitos, CA (US); Ashish Dhuldhoya, Chino Hills, CA (US)

Correspondence Address: KIT M. STETINA, STETINA BRUNDA GARRED & BRUCKER, SUITE 250, 75 ENTERPRISE, ALISO VIEJO, CA, 92656, US

(21) Appl. No.: 09/859,202

(22) Filed: May 16, 2001

(51) Int. Cl. C08K 3/00

(52) U.S. Cl. 524/871

(57) ABSTRACT

A polyurea sealant top-coat composition for application onto a substrate, including a polyester product. Two general two-component compositions are included, with the first component of the first composition including isophorone diisocyanate monomer; propylene glycol; siloxane leveling additive; diisononyl phthalate; dibutyltin dilaurate; and tris(6-isocyanatohexyl) isocyanurate. The second component of the first composition includes low-viscosity amine functional resin; isophorone diamine; long chain alcohol polar acidic ester; titanium dioxide; ground silica; aliphatic diamine chain extender; alumina silicate; silicon dioxide; silicon antifoam; anti-cratering silicon surface additive; acrylate leveling additive; hydroxyphenyl-benzotriazole ultraviolet absorber; sebacate light stabilizer; silane adhesion promoter; bismuth deconoate catalyst; ethylenediamine/propylene glycol catalyst; and dibutyltin dilaurate. The second coating composition has only tris(isocyanatohexyl) isocyanurate as the first component thereof, while the second component thereof contains the same ingredients as that of the first composition. First and second components are in a 1:1 weight ratio.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

This invention relates in general to polymer coatings, and in particular to a polyurea top-coat composition formulated for use as a sealant top-coat where volatile organic compounds may otherwise escape from a fabricated structure.

Employment of a combination of styrene and fiberglass in mixtures for construction of a multitude of various generally-rigid structures and structural constituents is well known and is non-limitedly exemplified in products such as sports equipment, vehicle components, and household wares. While products fabricated of these mixtures generally provide durability along with highly-favorable appearances, unseen and untoward reactions occur because of the materials used. Specifically, hazardous volatile organic compounds are released into the environment, with such volatile compounds being so unsafe that manufacturing processes are prohibited in the vicinities of schools and other population concentrations where health vulnerabilities are a consideration.

In view of the above described health factors and consequent workability issues in manufacturing-procedures, it is apparent that a need is present for a top-coat coating product that does not represent a health hazard during manufacture and that consequently does not result in emission of volatile compounds to the atmosphere. A primary object of the present invention therefore is to provide a composition for use as a sealant top-coat where volatile organic compounds may otherwise escape on fabrication of a structure.

Another object of the present invention is to provide a polyurea top-coat composition formulated to safely and effectively react during curing to prohibit untoward danger among workers and nearby members of the public.

Still another object of the present invention is to provide a top-coat composition whose appearance and durability are highly favorable.

These and other objects of the present invention will become apparent throughout the description thereof which now follows.

### BRIEF SUMMARY OF THE INVENTION

The present invention is a polyurea sealant top-coat composition for application onto a substrate, and, in particular, can replace a gel coat traditionally coating a polyester substrate. Two general two-component compositions are included, with the first component of the first composition comprising about 4-12 wt. % isophorone diisocyanate monomer; about 8-16 wt.% propylene glycol having a hydroxyl number of 102-112; about 0-1 wt. % poly-methyl-alkyl-siloxane leveling additive; about 2-5 wt. % diisononyl phthalate; about 0-1 wt. % dibutyltin dilaurate; and about 65-85 wt. % tris(6-isocyanatohexyl) isocyanurate. The second component of the first composition comprises about 30-50 wt. % low-viscosity amine functional resin; about 1-3 wt. % isophorone diamine; about 0-1 wt. % long chain alcohol polar acidic ester as a dispersing additive; about 10-20 wt. % titanium dioxide; about 15-20 wt. % ground silica; about 15-25 wt. % aliphatic diamine chain extender; about 1-3 wt. % alumina silicate; about 0-1 wt. % silicon dioxide about 0-1 wt. % silicon antifoam; about 0-1 wt. % anti-cratering silicon surface additive; about 0-1 wt. % solvent-free acrylate leveling additive; about 0-1 wt. % hydroxyphenyl-benzotriazole ultraviolet absorber; about 0-1 wt. % sebacate light stabilizer; about 0-1 wt. % silane adhesion promoter; about 0-1 wt. % bismuth deconoate catalyst; about 0-1 wt. % ethylenediamine/propylene glycol catalyst; and about 0-1 wt. % dibutyltin dilaurate. Both components preferably are provided in a 1:1 weight ratio to thereby form the first composition.

The second coating composition has a single ingredient, namely tris(isocyanatohexyl) isocyanurate, as the first component thereof, and a second component including about 5-15 wt. % low-viscosity amine functional resin; about 1-3 wt. % isophorone diamine; about 0-1 wt. % dispersing additive of long chain alcohol polar acidic ester; about 10-20 wt. % titanium dioxide; about 15-20 wt. % ground silica; about 40-60 wt. % aliphatic diamine chain extender; about 1-3 wt. % alumina silicate; about 0-1 wt. % silicon dioxide; about 0-1 wt. % silicon antifoam; about 0-1 wt. % anti-cratering silicon surface additive; about 0-1 wt. % solvent-free acrylate leveling additive; about 0-1 wt. % hydroxyphenyl-benzotriazole ultraviolet absorber; about 0-1 wt. % sebacate light stabilizer; about 0-1 wt. % silane adhesion promoter; about 0-1 wt. % bismuth deconoate catalyst; about 0-1 wt. % ethylene diamine/propylene glycol catalyst; and about 0-1 wt. % dibutyltin dilaurate. The respective two components of the respective compositions are combined, applied, and cured in the same manner as customarily employed in urea applications to thereby provide a top-coat coating whose properties are not only environmentally friendly, but also aesthetically appealing.

### BRIEF DESCRIPTION OF THE DRAWINGS

(Not Applicable)

### DETAILED DESCRIPTION OF THE INVENTION

The preferred first embodiment of a top-coat composition includes two components each fabricated as a respective separate mixture. The first component (commonly called an “A” component) of the first embodiment contains about 8-10 wt. % isophorone diisocyanate monomer; about 12-14 wt. % propylene glycol having a hydroxyl number of 102-112; about 0.04-0.06 wt. % poly-methyl-alkyl-siloxane leveling additive; about 3-5 wt. % diisononyl phthalate; about 0.04-0.06 wt. % dibutyltin dilaurate; about 70-80 wt. % tris(6-isocyanatohexyl) isocyanurate. The second component (commonly called a “B” component) contains about 40-42 wt. % low-viscosity amine functional resin; about 1-3 wt. % isophorone diamine; about 0-0.1 wt. % dispersing additive of long chain alcohol polar acidic ester; about 14-16 wt. % titanium dioxide; about 16-20 wt. % ground silica; about 18-22 wt. % aliphatic diamine chain extender; about 1-3 wt. % alumina silicate; about 0-1 wt. % silicon dioxide; about 0.01-0.05 wt. % silicon antifoam; about 0-0.1 wt. % anti-cratering silicon surface additive; about 0.3-0.5 wt. % solvent-free acrylate leveling additive; about 0-0.5 wt. % hydroxyphenyl-benzotriazole ultraviolet absorber; about 0-1 wt. % sebacate light stabilizer; about 0-1 wt. % silane adhesion promoter; about 0-0.1 wt. % bismuth deconoate catalyst; about 0-0.1 wt. % ethylene diamine/propylene glycol catalyst; and about 0-0.1 wt. % dibutyltin dilaurate.

The preferred second embodiment of a top-coat composition likewise includes two components, with the first or “A” component being a single compound and the second or “B” component being a separately prepared mixture. In particular, the first component is tris(isocyanatohexyl) isocyanurate, while the second component is a mixture of about 8-12 wt. % low-viscosity amine functional resin; about 1-3 wt. % isophorone diamine; about 0-1 wt. % dispersing additive of long chain alcohol polar acidic ester; about 12-18 wt. % titanium dioxide; about 15-20 wt. % ground silica; about 40-60 wt. % aliphatic diamine chain extender; about 1-3 wt. % alumina silicate; about 0-1 wt. % silicon dioxide; about 0-0.1 wt. % silicon antifoam; about 0-0.1 wt. % anti-cratering silicon surface additive; about 0-1 wt. % solvent-free acrylate leveling additive; about 0-1 wt. % hydroxyphenyl-benzotriazole ultraviolet absorber; about 0-1 wt. % sebacate light stabilizer; about 0-1 wt. % silane adhesion promoter; about 0-0.1 wt. % bismuth deconoate catalyst; about 0-0.1 wt. % ethylene diamine/propylene glycol catalyst; and about 0-0.1 wt. % dibutyltin dilaurate.

Application of each of the compositions is performed under standard conditions as generally recognized in the art for such procedures including those for application as a replacement for gel coatings on polyester products. In non-limited particularity, a dual-channel pressure spray apparatus can be employed for deposition of the “A” and “B” components on a substrate to be coated, with the mixed components thereafter permitted to first gel and then dry. The top-coat coating so produced provides a favorably-safe working environment without untoward volatile-organic-compound emissions while simultaneously delivering a coating that exhibits both a long-lasting utility and a pleasing appearance.

The following examples illustrate preferred embodiments for specific top-coat coatings.

### EXAMPLE 1

A first most-preferred coating composition comprising two components is prepared utilizing standard mixing procedure. The first component is prepared by combining about 8.57 wt. % isophorone diisocyanate monomer (Rhodia Corp., Product Data Sheet CCM FP 101); about 12.85 wt. % propylene glycol having a hydroxyl number of 102-112 (BASF Corp., PLURACOL P1010); about 0.05 wt. % poly-methyl-alkyl-siloxane leveling additive (BYK-Chemie USA, BYK-085); about 3.57 wt. % diisononyl phthalate (Exxon Chemical Co.; JAYFLEX Plasticizer); about 0.05 wt. % dibutyltin dilaurate catalyst (Witco Corp., FOMREZ SUL-4); and about 75 wt. % tris(6-isocyanatohexyl) isocyanurate (Rhone-Poulenc Corp., TOLONATE HDT).

The second component of the first coating composition is likewise prepared by combining about 40.3 wt. % low-viscosity amine functional resin (Bayer Corp., DESMOPHEN NH 1220); about 2 wt. % isophorone diamine (Creanova Inc., VESTAMIN IPD); about 0.4 wt. % long chain alcohol polar acidic ester dispersing additive (BYK-Chemie USA, DISPERPLAST 1142); about 15 wt. % titanium dioxide (Keer-McGee Chemical LLC, CR-880); about 18 wt. % ground silica (U.S. Silica Co., MIN-U-SIL) about 20 wt. % aliphatic diamine chain extender (UOP Corp., CLEARLINK 1000 DIAMINE); about 2 wt. % alumina silicate (UOP Corp., Molecular Sieve Type 3A); about 0.5 wt. % silicon dioxide (Degussa Corp., AEROSIL R972); about 0.02 wt. % silicon antifoam (Osi Specialties Corp., SAG 47 Silicone Antifoam Compound); about 0.05 wt. % anti-cratering silicon surface additive (BYK-Chemie USA, BYK-333); about 0.4 wt. % solvent-free acrylate leveling additive (BYK-Chemie USA, BYK-361); about 0.3 wt. % hydroxyphenyl-benzotriazole ultraviolet absorber (Ciba Specialty Chemicals Corp., TINUVIN 1130); about 0.6 wt. % sebacate light stabilizer (Ciba Specialty Chemicals Corp., TINUVIN 292); about 0.4 wt. % silane adhesion promoter (Osi Corp., SILQUEST A-187 Silanes); about 0.06 wt. % bismuth deconoate catalyst (OM Group, Inc., CATALYST 315); about 0.06 wt. % ethylene diamine/propylene glycol catalyst (E. F. Whitmore & Co., DABCO 33-LV); and about 0.03 wt. % dibutyltin dilaurate catalyst (Witco Corp., FOMREZ SUL-4).

Upon completion of individual component blending, the two components (“A” & “B”) are routinely combined and applied as a final top-coat finish and protectorant as a completed product is built.

### EXAMPLE 2

A second most-preferred coating composition comprising two components is likewise prepared utilizing standard mixing procedure. In this composition, the first component is a single compound, 100 wt. % tris(isocyanatohexyl) isocyanurate ((Rhone-Poulenc Corp., TOLONATE HDT). The second component of the second coating composition is prepared by combining about 10 wt. % low-viscosity amine functional resin (Bayer Corp., DESMOPHEN NH 1220); about 2 wt. % isophorone diamine (Creanova Inc., VESTAMIN IPD); about 0.4 wt. % long chain alcohol polar acidic ester dispersing additive (BYK-Chemie USA, DISPERPLAST 1142); about 15 wt. % titanium dioxide (Keer-McGee Chemical LLC, CR-880); about 18 wt. % ground silica (U.S. Silica Co., MIN-U-SIL) about 50 wt. % aliphatic diamine chain extender (UOP Corp., CLEARLINK 1000 DIAMINE); about 2 wt. % alumina silicate (UOP Corp., Molecular Sieve Type 3A); about 0.5 wt. % silicon dioxide (Degussa Corp., AEROSIL R972); about 0.02 wt. % silicon antifoam (Osi Specialties Corp., SAG 47 Silicone Antifoam Compound); about 0.05 wt. % anti-cratering silicon surface additive (BYK-Chemie USA, BYK-333); about 0.4 wt. % solvent-free acrylate leveling additive (BYK-Chemie USA, BYK-361); about 0.3 wt. % hydroxyphenyl-benzotriazole ultraviolet absorber (Ciba Specialty Chemicals Corp., TINUVIN 1130); about 0.6 wt. % sebacate light stabilizer (Ciba Specialty Chemicals Corp., TINUVIN 292); about 0.4 wt. % silane adhesion promoter (Osi Corp., SILQUEST A-187 Silanes); about 0.06 wt. % bismuth deconoate catalyst (OM Group, Inc., CATALYST 315); about 0.06 wt. % ethylene diamine/propylene glycol catalyst (E. F. Whitmore & Co., DABCO 33-LV); and about 0.03 wt. % dibutyltin dilaurate catalyst (Witco Corp., FOMREZ SUL-4).

As with the composition of Example 1, upon completion of individual component blending, the two components (“A” & “B”) of this second most-preferred embodiment are routinely combined and applied as a final top-coat finish and protectorant.

### EXAMPLES 3-25

Tables 1A and 1B, below, provide formulations for the preparation of 23 additionally preferred top-coat products according to the present invention. Table 1A lists components A1 through A5, while Table 1B lists components B1 through B8, with any combination of A1 through A4 with B1 through B5, or of A5 with B6 through B8, for ultimate combination and application as a top-coat finish and protectorant. All composotions shown in Tables 1A and 1B that are common to compositions employed in Examples 1 and 2, above, have the same source identification. Those not present in Examples 1 and 2 are individually identified within the Tables. Quantities are expressed in weight-percent approximate values.

TABLE 1A

| A-Component | A1 | A2 | A3 | A4 | A5 |
|---|---|---|---|---|---|
| Isophorone diisocyanate monomer | 8.57 | 10.97 | 13.02 | 15.08 | 12.0 |
| Propylene polyether polyol (mol. wt. | 12.85 | 16.49 | 19.53 | 22.62 | 18.0 |
| about 1,000) | | | | | |
| Diisononyl phthalate | 3.57 | 4.57 | 5.43 | 6.28 | 5.0 |
| Dibutyltin dilaurate | 0.05 | 0.05 | 0.05 | 0.05 | 0.05 |
| Tris (6-isocyanatohexyl) isocyanurate | 75.0 | 68.0 | 62.0 | 56.0 | 65.0 |

TABLE 1B

| B-Component | B1 | B2 | B3 | B4 | B5 | B6 | B7 | B8 |
|---|---|---|---|---|---|---|---|---|
| Low-viscosity | 40.3 | 40.3 | 40.3 | 40.3 | 40.3 | | | 22.0 |
| amine | | | | | | | | |
| functional resin | | | | | | | | |
| Isophorone | 2.00 | 2.00 | 2.00 | 2.00 | 2.00 | 2.00 | 2.00 | 2.00 |
| diamine | | | | | | | | |
| Long chain | 0.40 | 0.40 | 0.40 | 0.40 | 0.40 | 0.40 | 0.40 | 0.40 |
| alcohol polar | | | | | | | | |
| acidic ester | | | | | | | | |
| dispersing | | | | | | | | |
| additive | | | | | | | | |
| Aliphatic | 20.00 | 20.00 | 20.00 | 20.00 | 20.00 | 42.00 | 42.00 | 26.8 |
| diamine chain | | | | | | | | |
| extender | | | | | | | | |
| Ground silica | 18.0 | | | | | 18.0 | | 18.0 |
| Talc | | 18.00 | | | | | 18.0 | |
| (MP-1250, | | | | | | | | |
| Barretts | | | | | | | | |
| Minerals, Inc.; | | | | | | | | |
| Dillon MT) | | | | | | | | |
| Clay | | | 18.00 | | | | | |
| (SNOWTEX- | | | | | | | | |
| 45, U. S. | | | | | | | | |
| Silicon | | | | | | | | |
| Co.; Berkeley | | | | | | | | |
| Springs WV) | | | | | | | | |
| Calcium | | | | 18.00 | | | | |
| carbonate | | | | | | | | |
| (VICRON 15- | | | | | | | | |
| 15, Specialty | | | | | | | | |
| Minerals, Inc.; | | | | | | | | |
| Lucerne Valley | | | | | | | | |
| CA) | | | | | | | | |
| Polyoxypropylene | | | | | 18.00 | 18.00 | 18.00 | 18.00 |
| diamine | | | | | | | | |
| (mol. wt. about | | | | | | | | |
| 2,000) | | | | | | | | |
| (JEFFAMINE | | | | | | | | |
| D-2000, | | | | | | | | |
| Huntsman | | | | | | | | |
| Petrochemical | | | | | | | | |
| Corp., Austin, | | | | | | | | |
| Texas) | | | | | | | | |
| Silicon dioxide | 0.50 | 0.50 | 0.50 | 0.50 | 0.50 | 0.50 | 0.50 | 0.50 |
| Hydroxy- | 0.30 | 0.30 | 0.30 | 0.30 | 0.30 | 0.30 | 0.30 | 0.30 |
| phenyl- | | | | | | | | |
| benzotriazole | | | | | | | | |
| ultraviolet | | | | | | | | |
| absorber | | | | | | | | |
| Sebacate light | 0.60 | 0.60 | 0.60 | 0.60 | 0.60 | 0.60 | 0.60 | 0.60 |
| stabilizer | | | | | | | | |
| Bismuth | 0.06 | 0.06 | 0.06 | 0.06 | 0.06 | 0.10 | 0.10 | 0.06 |
| deconoate | | | | | | | | |
| catalyst | | | | | | | | |
| Ethylene | 0.06 | 0.06 | 0.06 | 0.06 | 0.06 | 0.10 | 0.10 | 0.06 |
| diamine/ | | | | | | | | |
| propylene | | | | | | | | |
| glycol | | | | | | | | |
| catalyst | | | | | | | | |
| Dibutyltin | 0.03 | 0.03 | 0.03 | 0.03 | 0.03 | | | |
| dilaurate | | | | | | | | |
| Titanium | 15.00 | 15.00 | 15.00 | 15.00 | 15.00 | 15.00 | 15.00 | 15.00 |
| dioxide | | | | | | | | |
| Alumina | 2.00 | 2.00 | 2.00 | 2.00 | 2.00 | 2.00 | 2.00 | 2.00 |
| silicate | | | | | | | | |
| Silicon | 0.02 | 0.02 | 0.02 | 0.02 | 0.02 | 0.02 | 0.02 | 0.02 |
| antifoam | | | | | | | | |
| Solvent-free | 0.40 | 0.40 | 0.40 | 0.40 | 0.40 | 0.40 | 0.40 | 0.40 |
| acrylate | | | | | | | | |
| leveling | | | | | | | | |
| additive | | | | | | | | |
| Silane adhesion | 0.40 | 0.40 | 0.40 | 0.40 | 0.40 | 0.80 | 0.80 | 0.80 |
| promoter | | | | | | | | |

The top-coat composition products here defined permit favorable usability and structure fabrication while producing visually appealing goods. While illustrative and presently preferred embodiments of the invention have been described in detail herein, it is to be understood that the inventive concepts may be otherwise variously embodied and employed and that the appended claims are intended to be construed to include such variations except insofar as limited by prior art.

1. A polyurea top-coat composition for application onto a substrate, including a polyester substrate, the composition comprising:
a) a first-component mixture comprising:
i. about 4-12 wt. % isophorone diisocyanate monomer;
ii. about 8-16 wt. % propylene glycol having a hydroxyl number of 102-112;
iii. about 0-1 wt. % poly-methyl-alkyl-siloxane;
iv. about 2-5 wt. % diisononyl phthalate;
v. about 0-1 wt. % dibutyltin dilaurate; and
vi. about 65-85 wt. % tris(6-isocyanatohexyl) isocyanurate; and
b) a second-component mixture comprising:
i. about 30-50 wt. % low-viscosity amine functional resin;
ii. about 1-3 wt. % isophorone diamine;
iii. about 0-1 wt. % long chain alcohol polar acidic ester dispersing additive;
iv. about 10-20 wt. % titanium dioxide;
v. about 15-20 wt. % ground silica;
vi. about 15-25 wt. % aliphatic diamine chain extender;
vii. about 1-3 wt. % alumina silicate;
viii. about 0-1 wt. % silicon dioxide;
ix. about 0-1 wt. % silicon antifoam;
x. about 0-1 wt. % anti-cratering silicon surface additive;
xi. about 0-1 wt. % solvent-free acrylate leveling additive;
xii. about 0-1 wt. % hydroxyphenyl-benzotriazole ultraviolet absorber;
xiii. about 0-1 wt. % sebacate light stabilizer;
xiv. about 0-1 wt. % silane adhesion promoter;
xv. about 0-1 wt. % bismuth deconoate catalyst;
xvi. about 0-1 wt. % ethylene diamine/propylene glycol catalyst; and
xvii. about 0-1 wt. % dibutyltin dilaurate.

2. A polyurea top-coat composition as claimed in claim 1 wherein the ratio by weight of the first and second component mixtures is about 1:1.

3. A polyurea top-coat composition as claimed in claim 1 comprising:
a) a first-component mixture comprising:
i. about 8-10 wt. % isophorone diisocyanate monomer;
ii. about 12-14 wt. % propylene glycol having a hydroxyl number of 102-112;
iii. about 0.04-0.06 wt. % poly-methyl-alkyl-siloxane leveling additive;
iv. about 3-5 wt. % diisononyl phthalate;
v. about 0.04-0.06 wt. % dibutyltin dilaurate; and
vi. about 70-80 wt. % tris(6-isocyanatohexyl) isocyanurate; and
b) a second-component mixture comprising:
i. about 40-42 wt. % low-viscosity amine functional resin;
ii. about 1-3 wt. % isophorone diamine;
iii. about 0-1 wt. % dispersing additive of long chain alcohol polar acidic ester;
iv. about 14-16 wt. % titanium dioxide;
v. about 16-20 wt. % ground silica;
vi. about 18-22 wt. % aliphatic diamine chain extender;
vii. about 1-3 wt. % alumina silicate;
viii. about 0-1 wt. % silicon dioxide;
ix. about 0.01-0.05 wt. % silicon antifoam;
x. about 0-0.1 wt. % anti-cratering silicon surface additive;
xi. about 0.3-0.5 wt. % solvent-free acrylate leveling additive;
xii. about 0-0.5 wt. % hydroxyphenyl-benzotriazole ultraviolet absorber;
xiii. about 0-1 wt. % sebacate light stabilizer;
xiv. about 0-1 wt. % silane adhesion promoter;
xv. about 0-0.1 wt. % bismuth deconoate catalyst;
xvi. about 0-0.1 wt. % ethylene diamine/propylene glycol catalyst; and
xvii. about 0-0.1 wt. % dibutyltin dilaurate.

4. A polyurea top-coat composition as claimed in claim 3 wherein the ratio by weight of the first and second component mixtures is about 1:1.

5. A polyurea top-coat composition as claimed in claim 3 comprising:
a) a first-component mixture comprising:
i. about 8.57 wt. % isophorone diisocyanate monomer;
ii. about 12.85 wt. % propylene glycol having a hydroxyl number of 102-112;
iii. about 0.05 wt. % poly-methyl-alkyl-siloxane leveling additive;
iv. about 3.57 wt. % diisononyl phthalate;
v. about 0.05 wt. % dibutyltin dilaurate; and
vi. about 75 wt. % tris(6-isocyanatohexyl) isocyanurate; and
b) a second-component mixture comprising:
i. about 40.3 wt. % low-viscosity amine functional resin;
ii. about 2 wt. % isophorone diamine;
iii. about 0.4 wt. % dispersing additive of long chain alcohol polar acidic ester;
iv. about 15 wt. % titanium dioxide;
v. about 18 wt. % ground silica;
vi. about 20 wt. % aliphatic diamine chain extender;
vii. about 2 wt. % alumina silicate;
viii. about 0.5 wt. % silicon dioxide;
ix. about 0.02 wt. % silicon antifoam;
x. about 0.05 wt. % anti-cratering silicon surface additive;
xi. about 0.4 wt. % solvent-free acrylate leveling additive;
xii. about 0.3 wt. % hydroxyphenyl-benzotriazole ultraviolet absorber;
xiii. about 0.6 wt. % sebacate light stabilizer;
xiv. about 0.4 wt. % silane adhesion promoter;
xv. about 0.06 wt. % bismuth deconoate catalyst;
xvi. about 0.06 wt. % ethylene diamine/propylene glycol catalyst; and
xvii. about 0.03 wt. % dibutyltin dilaurate.

6. A polyurea top-coat composition as claimed in claim 5 wherein the ratio by weight of the first and second component mixtures is about 1:1.

7. A polyurea top-coat composition for application onto a substrate, including a polyester substrate, the composition comprising:
a) a first component comprising 100 wt. % tris(isocyanatohexyl) isocyanurate; and
b) a second-component mixture comprising:
i. about 5-15 wt. % low-viscosity amine functional resin;
ii. about 1-3 wt. % isophorone diamine;
iii. about 0-1 wt. % dispersing additive of long chain alcohol polar acidic ester;
iv. about 10-20 wt. % titanium dioxide;
v. about 15-20 wt. % ground silica;
vi. about 40-60 wt. % aliphatic diamine chain extender;
vii. about 1-3 wt. % alumina silicate;
viii. about 0-1 wt. % silicon dioxide;
ix. about 0-1 wt. % silicon antifoam;
x. about 0-1 wt. % anti-cratering silicon surface additive;
xi. about 0-1 wt. % solvent-free acrylate leveling additive;
xii. about 0-1 wt. % hydroxyphenyl-benzotriazole ultraviolet absorber;
xiii. about 0-1 wt. % sebacate light stabilizer;
xiv. about 0-1 wt. % silane adhesion promoter;
xv. about 0-1 wt. % bismuth deconoate catalyst;
xvi. about 0-1 wt. % ethylene diamine/propylene glycol catalyst; and
xvii. about 0-1 wt. % dibutyltin dilaurate.

8. A polyurea top-coat composition as claimed in claim 7 wherein the ratio by weight of the first component and second component mixture is about 1:1

9. A polyurea top-coat composition as claimed in claim 7 comprising:
a) a first component comprising 100 wt. % tris(isocyanatohexyl) isocyanurate; and
b) a second-component mixture comprising:
i. about 8-12 wt. % low-viscosity amine functional resin;
ii. about 1-3 wt. % isophorone diamine;
iii. about 0-1 wt. % dispersing additive of long chain alcohol polar acidic ester;
iv. about 12-18 wt. % titanium dioxide;
v. about 15-20 wt. % ground silica;
vi. about 40-60 wt. % aliphatic diamine chain extender;
vii. about 1-3 wt. % alumina silicate;
viii. about 0-1 wt. % silicon dioxide;
ix. about 0-0.1 wt. % silicon antifoam;
x. about 0-0.1 wt. % anti-cratering silicon surface additive;
xi. about 0-1 wt. % solvent-free acrylate leveling additive;
xii. about 0-1 wt. % hydroxyphenyl-benzotriazole ultraviolet absorber;
xiii. about 0-1 wt. % sebacate light stabilizer;
xiv. about 0-1 wt. % silane adhesion promoter;
xv. about 0-0.1 wt. % bismuth deconoate catalyst;
xvi. about 0-0.1 wt. % ethylene diamine/propylene glycol catalyst; and
xvii. about 0-0.1 wt. % dibutyltin dilaurate.

10. A polyurea top-coat composition as claimed in claim 9 wherein the ratio by weight of the first component and second component mixture is about 1:1

11. A polyurea top-coat composition as claimed in claim 9 comprising:
a) a first component comprising 100 wt. % tris(isocyanatohexyl) isocyanurate; and
b) a second-component mixture comprising:
i. about 10 wt. % low-viscosity amine functional resin;
ii. about 2 wt. % isophorone diamine;
iii. about 0.4 wt. % dispersing additive of long chain alcohol polar acidic ester;
iv. about 15 wt. % titanium dioxide;
v. about 18 wt. % ground silica;
vi. about 50 wt. % aliphatic diamine chain extender;
vii. about 2 wt. % alumina silicate;
viii. about 0.5 wt. % silicon dioxide;
ix. about 0.02 wt. % silicon antifoam;
x. about 0.05 wt. % anti-cratering silicon surface additive;
xi. about 0.4 wt. % solvent-free acrylate leveling additive;
xii. about 0.3 wt. % hydroxyphenyl-benzotriazole ultraviolet absorber;
xiii. about 0.6 wt. % sebacate light stabilizer;
xiv. about 0.4 wt. % silane adhesion promoter;
xv. about 0.06 wt. % bismuth deconoate catalyst;
xvi. about 0.06 wt. % ethylene diamine/propylene glycol catalyst; and
xvii. about 0.03 wt. % dibutyltin dilaurate.

12. A polyurea top-coat composition as claimed in claim 11 wherein the ratio by weight of the first component and second component mixture is about 1:1.

13. A polyurea top-coat composition for application onto a substrate, including a polyester substrate, the composition comprising:
a) a first-component mixture comprising:
i. about 8-16 wt. % isophorone diisocyanate monomer;
ii. about 12-24 wt. % propylene polyether polyol with molecular weight about 1,000;
iii. about 3-7 wt. % diisononyl phthalate;
iv. about 0-1 wt. % dibutyltin dilaurate; and
v. about 55-75 wt. % tris(6-isocyanatohexyl) isocyanurate; and
b) a second-component mixture comprising:
i. about 30-50 wt. % low-viscosity amine functional resin;
ii. about 1-3 wt. % isophorone diamine;
iii. about 0-0.5 wt. % long chain alcohol polar acidic ester dispersing additive;
iv. about 10-20 wt. % titanium dioxide;
v. about 15-20 wt. % filler chosen from the group consisting of ground silica, talc, clay, and calcium carbonate;
vi. about 15-25 wt. % aliphatic diamine chain extender;
vii. about 1-3 wt. % alumina silicate;
viii. about 0-1 wt. % silicon dioxide;
ix. about 0-0.05 wt. % silicon antifoam;
x. about 0-1 wt. % silane adhesion promotor;
xi. about 0-1 wt. % solvent-free acrylate leveling additive;
xii. about 0-0.5 wt. % hydroxyphenyl-benzotriazole ultraviolet absorber;
xiii. about 0-1 wt. % sebacate light stabilizer;
xiv. about 0-0.1 wt. % bismuth deconoate catalyst;
xv. about 0-0.1 wt. % ethylene diamine/propylene glycol catalyst;
xvi. about 0-0.05 wt. % dibutyltin dilaurate; and
xvii. about 0-20 wt. % polyoxypropylene diamine with molecular weight about 2,000.

14. A polyurea top-coat composition as claimed in claim 13 wherein the ratio by weight of the first component and second component mixture is about 1:1.

15. A polyurea top-coat composition for application onto a substrate, including a polyester substrate, the composition comprising:
a) a first-component mixture comprising:
i. about 10-14 wt. % isophorone diisocyanate monomer;
ii. about 16-20 wt. % propylene polyether polyol with molecular weight about 1,000;
iii. about 4-6 wt. % diisononyl phthalate;
iv. about 0-0.1 wt. % dibutyltin dilaurate; and
v. about 60-70 wt. % tris(6-isocyanatohexyl) isocyanurate; and
b) a second-component mixture comprising:
i. about 20-25 wt. % low-viscosity amine functional resin;
ii. about 1-3 wt. % isophorone diamine;
iii. about 0-0.5 wt. % long chain alcohol polar acidic ester dispersing additive;
iv. about 10-20 wt. % titanium dioxide;
v. about 15-20 wt. % filler chosen from the group consisting of ground silica and talc;
vi. about 25-45 wt. % aliphatic diamine chain extender;
vii. about 1-3 wt. % alumina silicate;
viii. about 0-1 wt. % silicon dioxide;
ix. about 0-0.05 wt. % silicon antifoam;
x. about 0-1 wt. % solvent-free acrylate leveling additive;
xi. about 0-0.5 wt. % hydroxyphenyl-benzotriazole ultraviolet absorber;
xii. about 0-1 wt. % sebacate light stabilizer;
xiii. about 0-0.1 wt. % bismuth deconoate catalyst;
xiv. about 0-0.1 wt. % ethylene diamine/propylene glycol catalyst; and
xv. about 15-20 wt. % polyoxypropylene diamine with molecular weight about 2,000.

16. A polyurea top-coat composition as claimed in claim 15 wherein the ratio by weight of the first component and second component mixture is about 1:1.
